(19) United States
(12) Patent Application Publication
(10) Pub. No.: US 2025/0075875 A1
(43) Pub. Date: Mar. 6, 2025

(54) LIGHTING DEVICE FOR A VEHICLE

(71) Applicant: Hella GmbH & Co. KGaA, Lippstadt (DE)

(72) Inventors: Jeannette Jaßmeier, Salzkotten (DE); Hubert Kettelgerdes, Delbrück (DE); Christian Koerdt, Geseke (DE); Matthias Merschbrock, Geseke (DE); Sonja Seibt, Warburg (DE)

(21) Appl. No.: 18/952,301

(22) Filed: Nov. 19, 2024

Related U.S. Application Data
(63) Continuation of application No. PCT/EP2022/063855, filed on May 23, 2022.

(51) Int. Cl. F21S 45/10; F21S 41/141

(52) U.S. Cl. CPC F21S 45/10; F21S 41/141

(57) ABSTRACT

A lighting device for a vehicle comprises at least one light source, a fastening means, a control device adapted and arranged to control the light source, and a shielding adapted to electromagnetically shield the control device or parts of the control device. The shielding is arranged to be held on the fastening means.

### CROSS REFERENCE

This application claims priority to PCT Application No. PCT/EP2022/063855, filed May 23, 2022, the entirety of which is hereby incorporated by reference.

### FIELD OF THE INVENTION

The present invention relates to a lighting device for a vehicle and to a vehicle with such a lighting device.

### BACKGROUND OF THE INVENTION

Lighting devices for vehicles are disclosed in the state of the art in various forms. In novel lighting devices, the light source usually has a plurality of light-emitting diodes arranged in a matrix.

For example, in LED high-definition headlights, several tens of thousands of light-emitting diodes are arranged in a matrix-like manner. A desired light distribution is generated in these lighting devices by a control device. The control device is sensitive to electromagnetic influences. To achieve EMC protection, the control device is protected by means of a shielding.

Usually, the shielding is attached to the control device. Known shieldings resemble a box that is opened at the bottom and placed on the control device. This fastening is complex and requires special care in order not to damage the control device.

### BRIEF SUMMARY OF THE INVENTION

This is where the invention takes effect.

The problem underlying this invention is to propose a lighting device for a vehicle in which the control device is sufficiently protected against electromagnetic influences, this protection being achieved quickly and inexpensively.

According to the invention, this is achieved by a lighting device for a vehicle comprises at least one light source, a fastening means, a control device which is suitable and arranged to control the light source, and a shielding which is suitable for electromagnetically shielding the control device or parts of the control device, whereas the shielding being arranged to be held on the fastening means.

The shielding is not arranged on the control device, but on a fastening means. The fastening means can in principle be any surrounding component which is arranged in direct proximity to the control device in the lighting device. It is advantageous if the fastening means offers a certain stability so that the shielding can be arranged in a holding manner on the fastening means. An advantage of this solution is that no fastening must be made to the control device, which is sensitive to damage due to its construction.

It can be provided that the light source comprises semiconductor elements arranged in a matrix for the targeted generation of pixels of a light distribution. The semiconductor elements can be light-emitting diodes, for example. The light source is controlled by the control device to obtain a desired light distribution outside the lighting device. Known control methods work with pulse-width modulated signals in which the individual light-emitting diodes are switched on and off at very short intervals that are not visible to the human eye.

In order to achieve a quick and easy arrangement of the shielding on the fastening means, it can be provided that the holding arrangement of the shielding on the fastening means is carried out in a detachable manner, in particular by means of a screw connection, clamping and/or latching. The detachable connection makes it possible to attach and also remove the shielding without destroying or damaging the shielding and/or the fastening means. If a releasable arrangement is not desired or required, it may be provided that the retaining arrangement of the shielding to the fastening means is non-releasable, in particular by means of insert molding. The advantage of a non-detachable arrangement is that the shielding and the fastening means are firmly connected to each other. Even when the lighting device is in operation, there is no danger of the components becoming detached from each other and the EMC protection of the control device thereby being reduced or completely eliminated.

It is possible that the control device has at least a printed circuit board. The printed circuit board may be sensitive to electromagnetic influences in whole or in part, in particular the electronic component on printed circuit board. The shielding shall be sized and positioned to protect the areas of the printed circuit board that are sensitive to electromagnetic influences.

It can be provided that the shielding has at least one contact means, whereby a contact can be established between the shielding and the circuit board of the control device by means of the at least one contact means. It may be provided that the at least one contact means is a spring contact which is suitable for establishing a detachable contact between the shielding and the printed circuit board.

It is possible that the fastening means contains a plastic or is made of this material. If the fastening means is made of plastic, this allows many degrees of freedom in designing the shape of the fastening means with good dimensional stability.

Furthermore, it is possible that the shielding contains or consists of an electrically conductive material. If the shielding is made of an electrically conductive metal, this can be a metal for example, sufficient EMC protection can be made possible.

In particular, it is possible for the shielding to be part of the fastening means, for example by metallizing an area of the fastening means. It is conceivable that the metallization of a portion of the fastening means is applied to the fastening means or is introduced into the fastening means during the manufacturing process. This would make it possible to save the step of arranging the shielding on the fastening means. This allows a saving in production time and material costs. Both are components of the cost of the lighting device. A saving can therefore reduce the price. Particularly with large series products, even small savings in the costs of individual components lead to high savings for the series due to the high number of units.

It may be provided that the light source is arranged on the printed circuit board.

Furthermore, it may be provided that the lighting device also comprises optics adapted to refract the light emitted by the at least one light source and a heat sink adapted to dissipate the heat emitted by the at least one light source to the environment. The optics may have for example primary optics, reflectors, lenses or lens systems. It may be provided that the fastening means is suitable for holding at least the optics. The fastening means may be, for example, a carrier frame on which the individual components of the lighting device are arranged. Such a carrier frame is stable enough to hold the shielding and to allow a sufficiently accurate positioning over the location of the control device to be protected.

Advantageously, a vehicle is equipped with a lighting device according to the invention.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a perspective view of a lighting device according to the invention in a partially disassembled state from a first perspective.

FIG. 2a is a perspective view of a lighting device according to the invention in a partially disassembled state from a second perspective with the shielding not arranged.

FIG. 2b is a perspective view of a lighting device according to the invention in a partially disassembled state from a second perspective with the shielding arranged.

FIG. 3 is a section of the lighting device with shielding in place.

FIG. 4 is a perspective view of a lighting device according to the invention.

### DETAILED DESCRIPTION OF THE DRAWINGS

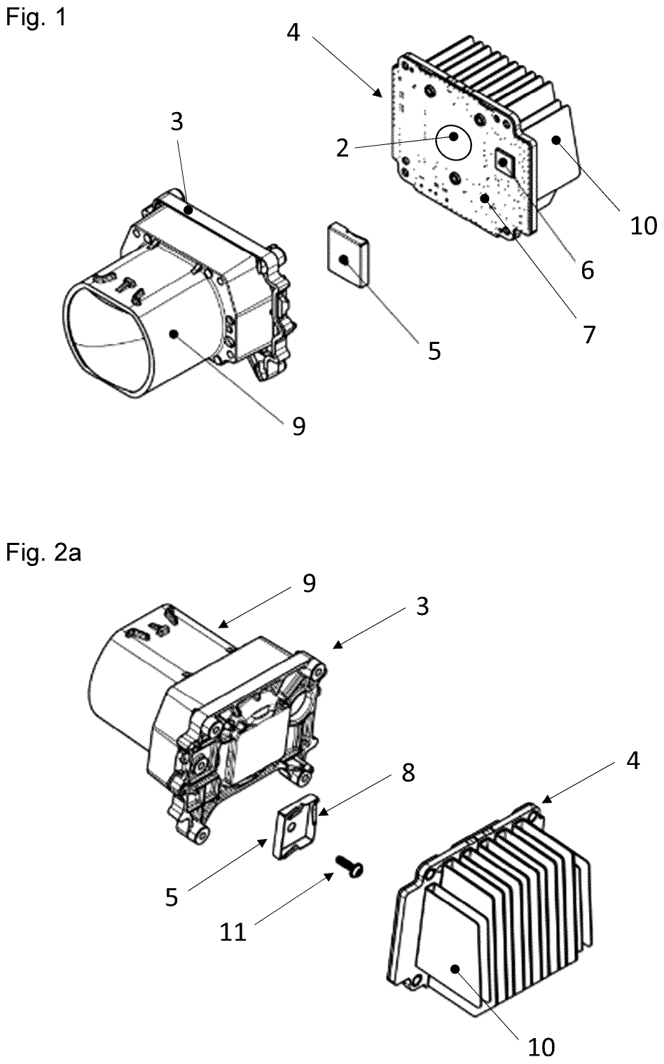

FIGS. 1, 2a and 2b each show a lighting device 1 with the features of the present invention from different perspectives in a partially disassembled state. The lighting device 1 has a light source 2, a fastening means 3, which can be a carrier frame in these figures, a control device 4 and a shielding 5. On the fastening means 3, which may for example be a plastic component, an optic 9 is arranged at the front and a heat sink 10 at the rear in the perspective of FIG. 1. The heat sink 10 serves to dissipate the heat generated by the light source 2.

FIG. 1 show the light source 2, which in the embodiment shown is formed by semiconductor elements arranged in a matrix for the targeted generation of pixels of a light distribution, such as a solid-state LED array or an SSL-HD-LED. The control device 4 is used to control the light source 2 in accordance with a desired light distribution characteristic, the light distribution thus generated being projected by the optics 9. According to the invention, the control device 4 is arranged in front of the heat sink 10 in the perspective of FIG. 1.

The control device 4 has a printed circuit board 7. In order to protect the control device 4 or parts of the control device 6, in particular the electronic component on printed circuit board from electromagnetic influences, FIGS. 1, 2a and 2b show a shielding 5 which is made of a metallic material according to the invention. In FIG. 2b the shielding 5 is arranged on the fastening means 3 by a screw connection by means of a screw 11.

In order to establish contact between shielding 5 and the circuit board 7 of the control device 4, the shielding 5 has contact means 8, here in the form of spring contacts, as shown in FIGS. 2a and 2b. In the assembled state of the lighting device, the spring contacts establish an electrical contact between the shielding 5 and the control device 4.

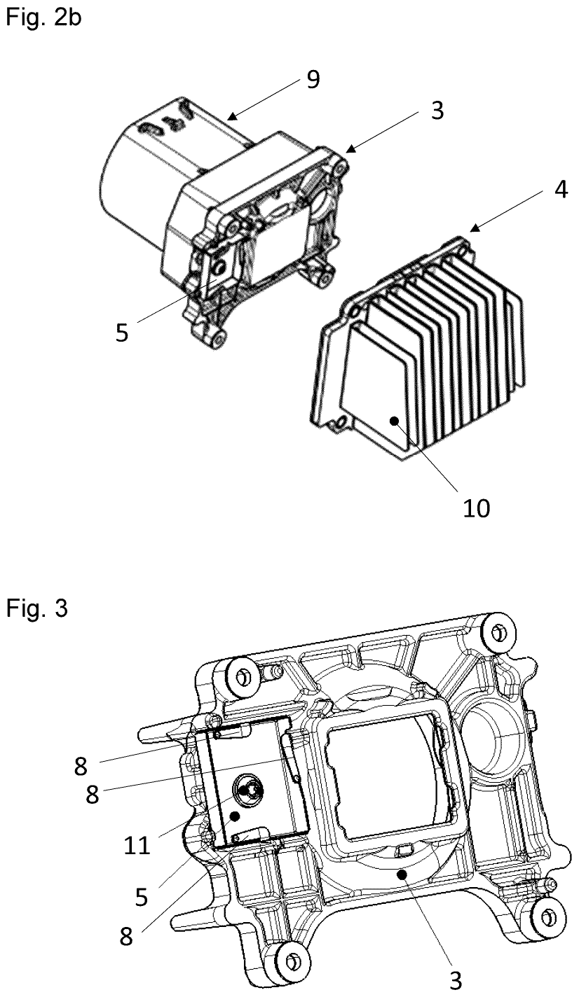

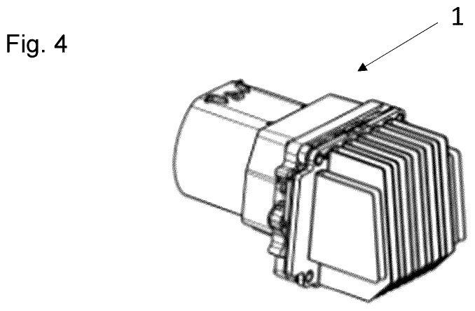

FIG. 3 shows an enlarged section of a part of FIG. 2b. Only the fastening means 3, the shielding 5, the screw 11 and the contact means 8 are shown. FIG. 3 clearly shows the arrangement of the shielding 5 on the fastening means 3, shown here as an example by means of a screw 11. In this enlarged section with only some components of the lighting device 1, the contact means 8 can be seen more clearly. In this example, the contact is made by three spring contacts.

If the lighting device 1 is assembled as shown in FIG. 3, the shielding 5 covers the part of the control device 4 which is to be protected against electromagnetic influences. In addition to the arrangement shown by means of a screw connection, other detachable and non-detachable fastening methods are conceivable which do not constitute an inventive step of the invention shown.

By arranging it on the fastening means 3, the shielding 5 is attached to a robust, insensitive component. This enables an arrangement that requires little care and can therefore be carried out more quickly. Also, the likelihood of damaging the control device 4 is minimized. This can lead to a reduction in rejects due to faulty lighting devices 1.

### LIST OF REFERENCE SIGNS

1 Lighting device
2 Light source
3 Fastening means
4 Control device
5 Shielding
6 Parts of the control device
7 Printed circuit board
8 Contact means
9 Optics
10 Heat sink
11 Screw

1. A lighting device for a vehicle, the lighting device comprising:
at least one light source;
a fastening means;
a control device arranged to control the at least one light source; and
a shielding positioned to electromagnetically shield the control device or parts of the control device, wherein the shielding is arranged to be held on the fastening means.

2. The lighting device according to claim 1, wherein the light source comprises semiconductor elements for the targeted generation of pixels of a light distribution.

3. The lighting device according to claim 1, wherein a retaining arrangement of the shielding on the fastening means is effected in a releasable manner.

4. The lighting device according to claim 1, wherein the retaining arrangement of the shielding on the fastening means is effected in a non-detachable manner, in particular by means of insert molding.

5. The lighting device according to claims 1, wherein the control device comprises at least one printed circuit board.

6. The lighting device according to claim 1, wherein the shielding has at least one contact means, it being possible to establish contact between the shielding and the control device by means of the at least one contact means.

7. The lighting device according to claim 6, wherein the at least one contact means is a spring contact suitable for establishing a detachable contact between the shielding and the control device.

8. The lighting device according to claim 1, wherein the fastening means contains or consists of a plastic material.

9. The lighting device according to claim 1, wherein the shielding contains or consists of an electrically conductive material.

10. The lighting device according to claim 1, wherein the shielding is part of the fastening means.

11. The lighting device according to claim 1, wherein the light source is arranged on the printed circuit board.

12. The lighting device according to claim 1, further comprising optics adapted to shape light emitted by the at least one light source.

13. The lighting device according to claim 1, further comprising a heat sink adapted to dissipate the heat emitted by the at least one light source to the environment.

14. A vehicle comprising at least one lighting device according to claim 1.

15. The lighting device according to claim 3, wherein a retaining arrangement of the shielding on the fastening means is one or more of a screw connection, clamping and latching.

16. The lighting device according to claim 4, wherein the retaining arrangement of the shielding on the fastening means is effected by insert molding.

17. The lighting device according to claim 10, wherein the shielding is part of the fastening means by metallizing a portion of the fastening means.
